(19) United States
(12) Patent Application Publication
(10) Pub. No.: US 2026/0036123 A1
(43) Pub. Date: Feb. 5, 2026

(54) COMPOSITE MEMBRANE FOR MEMBRANE PUMP

(71) Applicants: Joachim OEHRLE, Herrenberg (DE); Jiajia XU, Stuttgart (DE); Adithya Arun SHETTY, Neckarsulm (DE); Leon RADOM, Ellhofen (DE)

(72) Inventors: Joachim OEHRLE, Herrenberg (DE); Jiajia XU, Stuttgart (DE); Adithya Arun SHETTY, Neckarsulm (DE); Leon RADOM, Ellhofen (DE)

(21) Appl. No.: 19/280,901

(22) Filed: Jul. 25, 2025

(30) Foreign Application Priority Data
Aug. 5, 2024 (DE) 102024122239.5

(51) Int. Cl. F04B 53/00; B29C 45/14; B29K 21/00; B29K 705/00; F04B 45/04

(52) U.S. Cl. CPC F04B 53/00; B29C 45/14311; F04B 45/04; B29K 2021/003; B29K 2705/00

(57) ABSTRACT

A composite membrane for a membrane pump has an elastomeric body with an outer edge forming a clamping surface, a base forming a chamber, and a flexible membrane section connecting the outer edge to the base. An insert is at least partially in the chamber. A composite layer connects the insert to the body, has a thickness less than 100 μm, and is formed with a plurality of hook-shaped anchor elements engaging into the body.

### FIELD OF THE INVENTION

The present invention relates to a composite membrane, in particular for membrane pumps.

### BACKGROUND OF THE INVENTION

Such a composite membrane typically has an elastomeric body having an outer edge with a clamping surface, a base, and a flexible membrane section connecting the outer edge to the base. T the base forms a chamber that holds at least part of an insert. This insert is connected to the elastomeric body via a composite layer forming the surface at least in some areas. The lower and upper walls accordingly form the chamber holding the insert.

Such composite membranes are usually circular in shape and are basically flat. Against this background, they are also referred to as plate membranes. However, the invention is not limited to such designs but also relates to roll membranes, beaded membranes, dome-shaped membranes, and planar membranes. The corresponding composite membrane can be clamped at the edge in a membrane pump, while the base of the composite membrane is reciprocated so the flexible membrane section is turned at least partially inside out with each reciprocating movement and rolling movements of the flexible material can be observed in a radial section. Against this background, the flexible membrane section is also referred to as a roll loop in the prior art.

In contrast to the elastomeric body, the insert mounted in the base is made of an inflexible or dimensionally stable material, so that the base itself does not participate in the rolling movement but merely transmits the reciprocating movements to the flexible portion via a piston rod attached to the insert. For this purpose, the insert is between the upper and lower walls, the upper wall has an upper face turned toward the medium to be conveyed during normal use. Accordingly, the lower wall during normal use has a lower face directed away from the medium.

The elastomeric body usually has a polytetrafluoroethylene (PTFE) coating on the media side to ensure chemical resistance to the conveyed media.

The elastomeric body is made of an elastomeric material, usually rubber that is vulcanized into the elastomeric body to form a stable adhesive bond. To simplify this manufacturing process, thermoplastic elastomers (TPE) are increasingly being used for the elastomeric body. These are polymers that exhibit elastomeric properties in their normal state. However, they can be plastically deformed by the application of heat and thus brought into almost any desired shape.

One such design is taught, for example, in US 2011/0311379, where the elastomeric body is injection molded from the thermoplastic elastomer around an insert. However, particularly when thermoplastic elastomers are incorporated, it is problematic that these materials do not bond sufficiently to the insert, which is usually made of metal, without an additional chemical bonding system. Particularly with larger membrane diameters, the high surface forces and loads cause the elastomeric body made of a thermoplastic elastomer to detach from the insert. In principle, this problem can also occur with other plastic materials, but it is particularly problematic with thermoplastic elastomers. The detachment of the elastomeric body can also allow compressed air to enter the gap between the insert and the elastomeric body, which further accelerates the aforementioned process and can lead, for example, to the insert being torn out.

According to above-cited US 2011/0311379, this problem can be solved by attaching the elastomeric body made of a thermoplastic elastomer to the insert via an additional adhesive layer. In addition, the insert has openings into which the liquid elastomer is injected during manufacture, so that radial forces in particular can be compensated to a certain extent. However, these openings do not prevent compressed air from entering the area between the elastomeric body and the insert, or at least do not contribute significantly to a reduction in the amount of air. Thus, without the additional adhesive layer, it is not possible to ensure a permanent bond between the elastomeric body and the insert.

However, incorporating such an adhesive layer is both production-intensive and costly. Against this background, DE 10 2013 206 224 teaches a membrane for a membrane pump in which the surface is roughened by treatment with electromagnetic radiation, thereby enlarging the surface and resulting in better adhesion of the elastomeric body to the insert. However, it has been shown that the adhesion still needs improvement.

DE 10 2020 123 324 therefore describes a composite membrane in which the insert is at least partially formed from an open-pored material. Here, the insert is formed, for example, by first providing a base body made of a solid material, such as aluminum, in a casting mold and filling the casting areas between the casting mold and the solid material with heat-resistant and water-soluble filler particles. After casting, the filling particles can be washed out and pores open to the outside are formed, into which the material of the elastomeric body can penetrate.

Although this process has proven itself in principle, practical experience has shown that the production of such composite membranes is comparatively complex and therefore not cost-efficient compared to the composite membranes known to date.

### OBJECTS OF THE INVENTION

It is therefore an object of the present invention to provide an improved composite membrane for a membrane pump.

Another object is the provision of such an improved composite membrane for a membrane pump that overcomes the above-given disadvantages, in particular that is on the one hand characterized by a highly effective connection between the elastomeric body and the insert and on the other hand can be manufactured in a cost-efficient manner.

Another object is to provide an improved method of making such a composite membrane.

### SUMMARY OF THE INVENTION

This is attained by the instant invention by a composite membrane for a membrane pump having an elastomeric body with an outer edge forming a clamping surface, a base forming a chamber, and a flexible membrane section connecting the outer edge to the base. An insert is at least partially in the chamber, and a composite layer connecting the insert to the body has a thickness less than 100 μm and is formed with a plurality of hook-shaped anchor elements engaging into the body.

In this context, the composite layer is understood to mean an area of the insert extending inwardly from the surface and in which all anchor elements are within this composite layer. The thickness of the composite layer extends essentially from the surface up to where all the anchor elements are enclosed by it.

Accordingly, a composite membrane is created that has microscopic anchoring elements in a comparatively thin area of the insert, which, due to their large number, are suitable for holding the elastomeric body to the insert. It is essential that a stable bond between the insert and the elastomeric body is maintained even under dynamic loads. At the same time, the microscopic anchoring elements can be created by surface treatment or surface structuring of the insert, so that the insert does not have to be formed by the design of macroscopic anchoring elements. This makes the manufacturing process particularly fast and cost efficient. Of course, it is also possible within the scope of the invention to provide additional design measures to prevent the elastomeric body from detaching. For example, holes can be provided in the insert parallel to the center axis, into which the material of the elastomeric body engages or extends.

According to a particularly preferred further development of the invention, the composite layer has a thickness of less than 70 μm, in particular less than 50 μm. A design in which the composite layer has a thickness of between 0.5 and 100 μm, in particular between 10 and 50 μm, is also particularly preferred.

It should be understood that the composite layer does not have to form the entire surface of the insert. Rather, the inventive composite layer can form only part of the surface of the insert, in which case the composite layer is arranged in particular where the greatest loads act between the elastomeric body and the insert during use of the composite membrane.

As explained above, the anchor elements are microscopic anchor elements. These preferably have, at least in part, but preferably all, a maximum extension of between 0.2 and 30 μm, in particular between 0.5 and 10 μm. The greatest extension is understood here to be the distance of the anchor elements that, regardless of their orientation, extend freely from other anchor elements. This is usually an extension in the thickness direction or an extension which is essentially perpendicular to the surface. In addition, the surface layer preferably has an anchor element density of between 500 and 100,000 anchor elements/mm5, in particular between 5000 and 50,000 anchor elements/mm5.

According to a preferred further development of the invention, the composite layer is formed by an etching process, in particular a wet chemical etching process. This is therefore a surface treatment in which the surface properties are specifically modified. An etching process known as “nanoscale sculpturing” is particularly preferred here. Such an etching process is described, for example, in U.S. Pat. No. 11,085,117. Here, the surface of the insert is treated in a chemical etching bath. This results in structuring of the surface through the etching action of an etching solution. The type of etching solution depends on the material of the insert to be processed, whereby an aqueous etching solution with a weight proportion of 7.25% hydrochloric acid (HCL) is usually used. Etching is carried out at room temperature without stirring the liquid. This process dissolves the particularly easily soluble components of the surface, so that the insert or surface is not damaged in terms of its structure. Instead, the dissolution of individual components forms corresponding anchor elements that are then responsible for the particularly good bond between the elastomeric body and the insert.

Anchor elements which are at least partially formed from cuboid sections are particularly preferred in this context. Such a design can be achieved in a particularly advantageous manner if the insert is at least partially made of aluminum. The cuboid sections have an essentially rectangular design. The size of these sections is generally between 20 nm and 50 μm.

In this case, it is particularly preferred if the anchor elements are at least partially formed from a plurality of rectangular sections arranged in an interlocking manner. Accordingly, the anchor elements or the hook shape can be achieved by the arrangement of the rectangular sections, with individual rectangular sections then offset or interlocked with one another. The anchoring elements then usually have a shape that decreases in width toward the outer ends. Such a design cannot be achieved with pure surface etching without restructuring.

Preferably, the composite layer is preferably formed from an identical material at least in sections adjacent to the composite layer. This makes it clear that the composite layer is not a coating applied as a supplement, but rather that the composite layer is formed as an integral surface section of the insert.

According to a preferred further development of the invention, the insert has a density of between 2.5 and 8.8 g/cm³ at least in the sections adjacent to the composite layer. This refers not to the material but to the sections of the insert, it being clear that the sections adjacent the composite layer are preferably formed from a solid material. In particular, all areas outside the composite layer of the insert are formed with a corresponding density or from a solid material.

It is particularly preferred that the insert is at least partially, but especially completely, made of aluminum, brass, or steel, especially stainless steel. In the case of aluminum, the sections adjacent to the composite layer have a density between 2.5 and 3 g/cm³, in the case of brass between 8 and 9 g/cm³, and in the case of steel between 7.5 and 8.2 g/cm³.

A further development of the invention provides that the elastomeric body has an upper wall and a lower wall together forming the chamber and a lower wall and that the composite layer is connected at least to the lower wall. This design prevents the radial forces caused by the lifting movement from causing the lower wall to detach from the insert. At the same time, the penetration of the material of the elastomeric body into the composite layer effectively blocks the cavities of the composite section, so that the entry of compressed air both through the cavities and through any passages formed between the lower wall and the composite section is effectively reduced or even completely prevented. The entry of compressed air increases the risk of the elastomeric body detaching from the insert, which significantly extends the service life of the composite membrane.

According to a further development of the invention, the composite section can also connect to both walls. Accordingly, the insert is then designed with a corresponding composite section at least in the areas adjacent to the walls. According to such a design, the material of the elastomeric body can engage in the composite section on both the upper and lower walls. This also forms a composite bond between the upper wall and the insert, which in particular absorbs the surface forces acting on the composite membrane, which arise during the stroke movement due to a temporary negative pressure. In this configuration, the elastomeric body is effectively prevented from detaching as a result of both the surface forces acting axially and radially. In this context, the axial direction refers to a direction parallel to the center axis of the composite membrane.

A preferred further development of the invention provides that the elastomeric body has at least one base layer made of a thermoplastic elastomer (TPE) adjacent the insert. This may be, in particular, a thermoplastic polyurethane (TPU), a cross-linked thermoplastic elastomer (TPV) or a thermoplastic polyester elastomer (TPC).

However, other types of thermoplastic polymers are also suitable in principle. Alternatively, the elastomeric body can also be made of acrylonitrile-butadiene rubber (NBR), ethylene-propylene-diene rubber (EPDM), chloroprene rubber (CR), styrene-butadiene rubber (SBR), a fluorine rubber mixture (FKM) or silicone rubber (VMQ).

In addition, the elastomeric body may also have a backing film, usually on the front side of the elastomeric body and in contact with the medium to be conveyed. Particularly in the case of chemically aggressive media, it may be advisable to provide a backing film made of a chemically resistant material in order to ensure the longest possible service life. This material may consist, for example, of PTFE or an ultrahigh molecular weight polyethylene.

According to a preferred embodiment of the invention, the insert also has a connection for a piston rod that can generally be fastened to the insert by a screw connection, a press fit or a form fit. A screw connection is particularly preferred in this context, as the piston rod can thus be easily detached from the composite membrane. According to such a design, the insert has an internal thread fitting complementarily with an external thread on the piston rod. This internal thread can be formed directly in the insert or in the material of the insert. Alternatively, a threaded sleeve can be in the insert, in which case the internal thread is provided in the threaded sleeve. The threaded sleeve is in turn connected to the insert, which is possible with a press fit or also by complementary form fit.

In addition, the present invention also teaches a diaphragm pump with a composite diaphragm according to the invention.

Furthermore, a method of making a composite membrane according to the invention is also the subject of the present invention. This method is particularly intended for making a composite membrane according to the invention, where an insert is first provided having, at least in sections, a composite layer forming the surface that is formed with a plurality of hook-shaped anchor elements, and where the composite layer has a thickness of less than 100 μm. The insert is then encapsulated with a molten elastomer to form the elastomeric body.

A preferred further development of the method provides that the insert is treated at least partially on the surface prior to provision using an etching method, in particular a wet-chemical etching method in which the composite layer with a plurality of anchor elements is formed in the course of the treatment. In particular, the nanoscale sculpturing already mentioned in connection with the composite membrane is used here.

### BRIEF DESCRIPTION OF THE DRAWING

The above and other objects, features, and advantages will become more readily apparent from the following description, reference being made to the accompanying drawing in which:

FIG. 1 is a section through a composite membrane according to the invention;

FIG. 2A is a large-scale view of a detail of FIG. 1;

FIG. 2B is a large scale view of the detail indicated at circle IIB in FIG. 1; and

FIG. 3 is a section through an alternative insert.

### SPECIFIC DESCRIPTION OF THE INVENTION

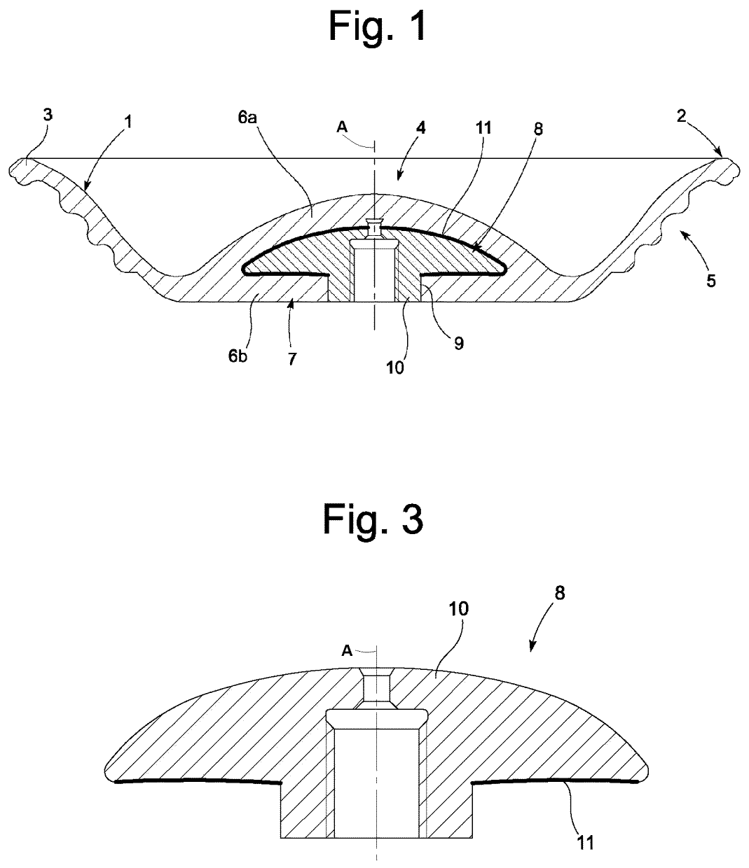

FIG. 1 shows a composite membrane according to the invention having an elastomeric body 1 rotationally symmetrical about an axis A and made of a thermoplastic elastomer with an outer edge 2, a clamping surface 3, a base 4, and a flexible portion 5 connecting the outer edge 2 to the base 4. The base 4 is formed by an upper wall 6a and a lower wall 6b that together form a chamber 7 holding most of an insert 8.

The insert 8 extends through an opening 9 in the lower wall 6b and forms a collar 10 at a lower end that is flush with the planar lower face of the lower wall 6b.

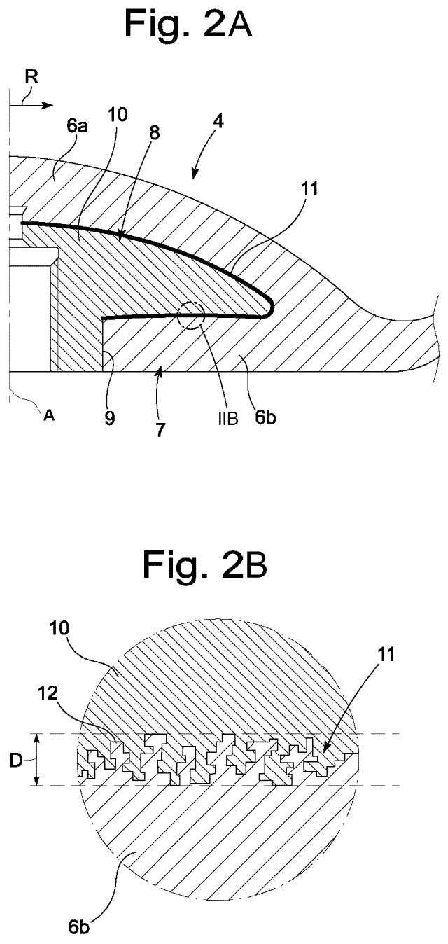

The insert 8 also has an annular composite layer 11 on its lower face completely surrounding the collar 10. The composite layer 11 differs from the collar in that the insert 8 is essentially made of a solid material, while the composite layer 11 is designed to bond the elastomeric body 1 to the insert 8. This is achieved by treating the surface of the insert to form the composite layer 11 using an etching process. In particular, this is a wet chemical etching process that transforms the surface of the insert 8. This is particularly clear from FIG. 2B.

This FIG. 2B shows in particular that the composite layer 11 has a plurality of hook-shaped anchoring elements 12 that are each formed from a plurality of cuboid sections that interlock with similar and complementary the anchoring elements or hooks 12 of the lower wall 6b. The anchor elements 12 are then gripped by the material of the elastomeric body 1, so that the thermoplastic elastomer of the elastomeric body 1 and the composite layer 11 of the insert 8 form a strong mechanically connection or bond that in particular withstands the dynamic loads applied to the composite membrane in use.

The composite layer 11 has a thickness D of less than 100 μm, in particular less than 70 μm, and preferably less than 50 μm. It is preferred that the thickness D is between 0.5 and 100 μm.

The composite layer 11 is dimensioned such that all of the anchor elements 12 are within this composite layer 11. The anchor elements have a maximum extension of between 0.2 and 30 μm. The maximum extension of the anchor elements 12 is usually in the thickness direction or parallel to the central axis A of the membrane 1. The anchor elements 12 also usually have a shape that increases axially, that is in the thickness direction.

The insert 8 can usually be made of aluminum, brass, or steel, in particular stainless steel, and the composite layer 11 is formed exclusively by a transformation of the surface of the insert 8.

FIG. 2 also shows that the insert 8 has a composite layer 11 both on its lower face turned toward the lower wall 6b and on its convex upper face turned toward and engaging the upper wall 6a, so that the elastomer body 1 is attached to the insert 8 via both walls 6a and 6b.

FIG. 3 shows a design in which a composite layer 11 is provided only on a lower face of the insert 8, so that the insert 8 can be attached to the elastomeric body 1 exclusively via the lower wall 6b.

1. A composite membrane for a membrane pump comprising:
an elastomeric body having an outer edge with a clamping surface, a base forming a chamber, and a flexible membrane section connecting the outer edge to the base;
an insert at least partially in the chamber; and
a composite layer connecting the insert to the body, having a thickness less than 100 μm, and formed with a plurality of hook-shaped anchor elements engaging into the body.

2. The membrane according to claim 1, wherein the composite layer has a thickness between 0.5 and 100 μm.

3. The membrane according to claim 1, wherein the anchor elements have at least partially a maximum extension between 0.2 and 30 μm.

4. The membrane according to claim 1, wherein the anchor elements are formed by wet-chemical etching of the insert.

5. The membrane according to claim 1, wherein the anchor elements are formed at least partially from cuboid formations.

6. The membrane according to claim 5 wherein the cuboid formations interlock with material forming the body.

7. The membrane according to claim 1, wherein the composite layer and a surface of the insert engaging the composite layer are of the same material.

8. The composite membrane according to claim 7, wherein the insert has a density of between 2.5 and 8.8 g/cm; at least in a part adjacent the composite layer.

9. The composite membrane according to claim 1, wherein the insert is made of aluminum, brass, or stainless steel.

10. The composite membrane according to claim 1, wherein the elastomeric body has an upper wall and a lower wall forming a chamber holding at least part of the insert and the composite layer least on the lower wall.

11. The composite membrane according to claim 10, wherein the composite layer is connected to the upper and lower walls.

12. The composite membrane according to claim 1, wherein the elastomeric body has at least one base layer made of a thermoplastic elastomer directly engaging the insert.

13. A method of making a composite membrane according to claim 1, wherein an insert is provided which has, at least in sections, a composite layer forming an outer surface and formed with a plurality of hook-shaped anchor elements, the composite layer has a thickness of less than 100 μm, and the insert encapsulated with a molten elastomer to form the elastomeric body.

14. The method according to claim 13, wherein the insert is provided with the hook-shaped anchor elements by treating at least a partial surface of the insert with a wet-chemical etching process prior to encapsulation with the elastomer.
